(19) United States
(12) Patent Application Publication
(10) Pub. No.: US 2005/0230023 A1
(43) Pub. Date: Oct. 20, 2005

(54) No holes pin

(76) Inventor: Nicolette Theresa Hunter, Baltimore, MD (US)

Correspondence Address: Nicolette T. Hunter, 7106 Ruthgreen Road, Baltimore, MD, 21244, US

(21) Appl. No.: 10/827,451

(22) Filed: Apr. 20, 2004

(51) Int. Cl. B32B 31/00

(52) U.S. Cl. 156/60

(57) ABSTRACT

Holes, in a silk or other expensive garment, have prevented the use of decorative jewelry to add accessories to enhance its beauty. Because most pins use a fabric piercing method of attaching pins or other jewelry, people who have expensive garments usually forego use of them. This system of non-fabric piercing pins will make it possible to attach a decorative piece of jewelry to a garment without damaging the fabric. Through the use of appropriately used glue and magnets, inexpensive and easily available products, this system results in an enhanced utility for expensive or less expensive jewelry.

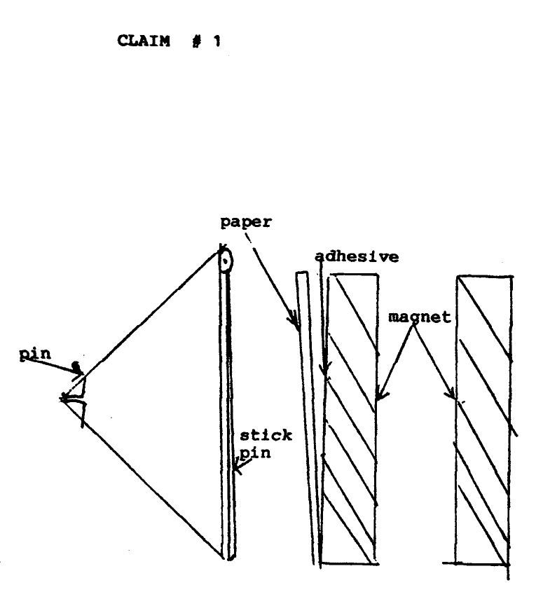

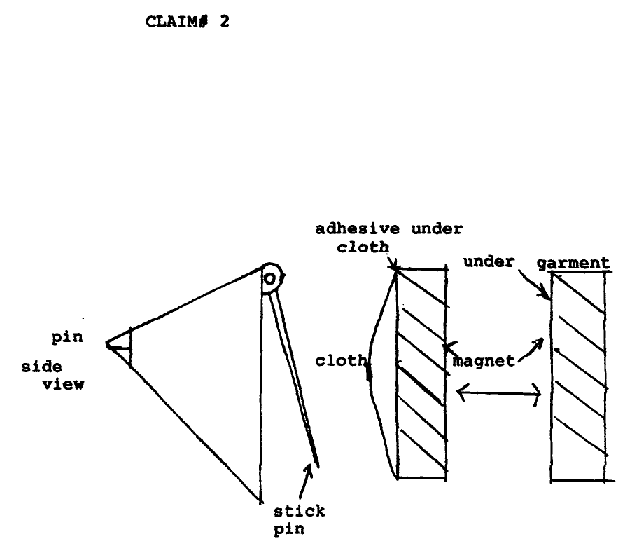

This invention consists of a system of commonly used objects which are organized in a less than usual fashion to achieve an other than usual result. The use of jewelry to enhance the appearance of a garment is a common practice. The traditional method to attach a pin is a part which punctures fabric. Instead, this system allows for attachment of a pin through the use of non-fabric puncturing magnets, one on the outside which is attached to a magnet on the inside of a garment. Pins with attached magnets which adhere to clothing in this manner can be readily and easily purchased. This system allows a person to convert any pin, even one which is not physically attached to a magnet, to one which is attached to a magnet. Once attached, the attraction of the magnets keeps the piece of jewelry in place. This system prevents damage to expensive fabrics by pins which are held on a garment by the usual method.

### BACKGROUND OF THE INVENTION

A non-fabric-penetrating method for the attachment of a piece of jewelry is not a new or unique device. Jewelry manufacturers have produced a piece of jewelry, usually a pin, to be worn on a garment, and included a pair of magnets, rather than a pin for its adherence. One magnet is attached to the piece of jewelry and cannot be separated from it to be used with another piece of jewelry. The other magnet is on the inside of the garment to hold the pin in place through the attraction of the magnets to each other.

### BRIEF SUMMARY OF CLAIM #1

The system of magnets just described is like the system used in this product. The unique characteristic of this system is that it can be used to convert any pin or other piece of jewelry from a fabric penetrating one to a non-fabric penetrating one.

### BRIEF DESCRIPTION OF CLAIM #2

This invention allows any pin to be converted to a non-fabric penetrating one and that pin can be removed and another pin can be inserted. This invention can be used over and over to change all of a person's cloth-puncturing pins to a non-cloth puncturing one.

### DETAILED DESCRIPTION OF CLAIM #1

One magnet with adhesive on one side is provided. This magnet is attached to the back of the piece of jewelry by the adhesive, after peeling off its covering. The jewelry is placed on the outside of the garment, and the second supplied magnet is placed on the inside of the garment on the opposite side to hold the jewelry in place, just as in the method described above. The unique feature is that this system can be used in a one-time process to convert any single piece of jewelry from a fabric-penetrating one to a non-penetrating-fabric one.

### DETAILED DESCRIPTION OF CLAIM #2

A magnet is coated with adhesive on one side and then fabric is added over that adhesive. Any pin is attached to the magnet by piercing the fabric. The pin is then put in place and a matching magnet is put inside the garment to hold the pin or other jewelry in place.

### BRIEF DESCRIPTION OF THE DRAWINGS

Claims #1

The drawing shows the correct position for the parts of the “No Holes Pin on the garment.

The pin and one magnet are located on the outside of the garment and the other magnet is located inside the garment. The magnet on the outside of the garment has a peel-off paper covering over an adhesive strip.

### DETAILED DESCRIPTION OF THE DRAWINGS

Claims #1

The drawing shows a lateral view of the system. The peel-off paper strip is removed to reveal an adhesive strip. The adhesive strip is attached to the back of the pin or other jewelry. The strip remains permanently attached to the pin or other jewelry and allows it to attach to clothing when the two magnets attract each other.

### BRIEF DESCRIPTION OF THE DRAWINGS

Claims #2

The drawing shows a lateral view of the system as it is attached to the garment. The pin or other jewelry adheres to the garment when the magnets attract each other.

### DETAILED DESCRIPTION OF THE DRAWING

Claims #2

The lateral view of the pin shows the correct position of the system. The magnet on the outside of the garment has fabric attached to it with adhesive. The stick pin of the jewelry pierces the fabric and is locked as usual. The inner magnet is placed on the inside of the garment opposite its mate on the outside. The pin or other jewelry adheres to the garment when the two magnets attract each other.

1. What I claim as my invention is the use of adhesive on magnets to attach to a pin in order to hold it in place and, adhesive plus fabric to hold any number of pins in place. Adhesive-covered magnets have been used to hold badges and other objects to a person's clothing. The use of the adhesive-coated magnets for pins or other pieces of jewelry is a new application.

2. I claim the use of adhesive to cause a pin to adhere to a magnet permanently.

3. I claim the use of adhesive plus cloth to allow each person to convert any number of pins to non-fabric penetrating ones.
